(19) United States
(12) Patent Application Publication
(10) Pub. No.: US 2022/0215248 A1
(43) Pub. Date: Jul. 7, 2022

(54) METHOD AND SYSTEM FOR MACHINE LEARNING USING A DERIVED MACHINE LEARNING BLUEPRINT

(71) Applicant: Covid Cough, Inc., Greenwood Village, CO (US)

(72) Inventors: Maurice A. Ramirez, Lake Wales, FL (US); Mark Fogarty, Seneca, SC (US); Michael V. Bivins, Orlando, FL (US); Robert Durham, Jacksonville, FL (US); Allison A. Sakara, Lake Wales, FL (US); Mona Kelley, Springfield, TN (US); Karl Kelley, Springfield, TN (US); Morgan Cox, Lakewood, CO (US); Nolan Donaldson, Denver, CO (US); Adam Stogsdil, Cypress, TX (US); Simon Kotchou, Phoenix, AZ (US); Robert F. Scordia, Brooklyn, NY (US); Kitty Kolding, Parker, CO (US); Anne Humpich, Downers Grove, IL (US); Michelle Archuleta, Lakewood, CO (US)

(21) Appl. No.: 17/568,539

(22) Filed: Jan. 4, 2022

Related U.S. Application Data
(60) Provisional application No. 63/133,446, filed on Jan. 4, 2021.

(51) Int. Cl. G06N 3/08

(52) U.S. Cl. CPC G06N 3/08

(57) ABSTRACT

Systems and methods of the present disclosure enable signal data signature detection using a memory unit and processor, where the memory using stores a computer program or computer programs created by the physical interface on a temporary basis. The computer program, when executed, cause the processor to perform steps to receive a signal data signature recording from at least one data source, receive a dataset of labeled signal data signature recordings including signal data signature recording labels, identify, using at least one machine learning model, boundaries within the dataset of labeled signal data signature recordings, classify the signal data signature recording to produce an output label using a compendium of signal data signature classifiers based on the boundaries within the dataset of labeled signal data signature recordings, determine an output type of the signal data signature recording, and display the output label on a display media.

### RELATED APPLICATION(S)

This application claims priority to and the benefit of U.S. Provisional Application No. 63/133,446, filed Jan. 4, 2021, which is hereby incorporated by reference in its entirety.

### TECHNICAL FIELD

The present disclosure relates generally to machine learning classifiers utilizing-a strategic machine learning as a method and system for use of federated data, machine learning and swarm learning for a derived strategic blueprint facilitating machine learning across data boundaries derived blueprint.

### BACKGROUND

Deep learning approaches have caused tremendous advances in many areas of computer science. Deep learning is a branch of machine learning where the learning process is done using deep and complex architectures such as recurrent convolutional artificial neural networks. Many computer science applications have utilized deep learning such as computer vision, speech recognition, natural language processing, sentiment analysis, social network analysis, and robotics. The success of deep learning enabled the application of learning models such as reinforcement learning in which the learning process is only done by trial-and-error, solely from actions rewards or punishments. Deep reinforcement learning come to create systems that can learn how to adapt in the real world. As deep learning utilizes deep and complex architectures, the learning process usually is time and effort consuming and need huge labeled data sets. This inspired the introduction of transfer and multi-task learning approaches to better exploit the available data during training and adapt previously learned knowledge to emerging domains, tasks, or applications.

Traditional deep learning based approaches have been applied to develop classifiers for a number of respiratory illnesses using cough signal data signature recordings. The challenge with deep learning models that are very specialized to a particular domain or even a specific task is that they are unable to differentiate or further classify negatives. There becomes an uncertainty about whether there is a certain degree of statistical luck as opposed to further discrimination and classification of the negative category. Deep learning models can be trained for classification and prediction tasks, however they are constrained by sample imbalance. In order for a deep neural network to be predictive across multiple applications it must be given a balanced set of labeled signal data.

The free flow of data across borders is essential for the digital economy, yet many governments place restrictions on the movement of data internationally. Cross-border flows of data are currently regulated by a number of international, regional and national instruments and laws intended to protect individuals' privacy, the local economy or national security. Other data barriers may exist, as well, such as bandwidth and networking limitations, etc.

The increased digitalization of organizations, driven by the rapid adoption of technologies such as cloud computing and data analytics, has increased the importance of data, impacting not just information industries, but traditional industries as well. The use of data analytics in virtually all industries has increased efficiency, and made the movement of data more important. Organizations increasingly rely on data for a number of purposes, including to monitor production systems, manage global workforces, monitor supply chains, and support products in the field in real time. Organizations collect and analyze personal data to better understand customers' preferences and willingness to pay, and adapt their products and services accordingly.

Barriers to data flows, such as data-residency requirements that confine data within a country's borders, a concept known as “data localization,” as well as technical impediments to sharing data exist that provide obstacles to efficient implementation of data analytics. Data localization can be explicitly required by law or is the de facto result of a culmination of other restrictive policies that make it unfeasible to transfer data, such as requiring companies to store a copy of the data locally, requiring companies to process data locally, and mandating individual or government consent for data transfers.

Prior solutions are limited by software programs that require human input and human decision points, algorithms that fail to capture the underlying distribution of signal data signature, algorithms that require balanced datasets, algorithms that are brittle and unable to perform well on datasets that were not present during training. Many governments place restrictions on the movement of data internationally that prior solutions fail to resolve or address.

### SUMMARY OF THE DISCLOSURE

This specification describes a signal data signature detection system that includes a machine learning derived strategy for training a compendium of signal data signature classifiers by applying signal data signature classifiers at the natural boundaries within the dataset (e.g., underlying features that lead to class distinctions). The signal data signature detection system components include input data, computer hardware, computer software, and output data that can be viewed by a hardware display media or paper. A hardware display media may include a hardware display screen on a device (computer, tablet, mobile phone), projector, and other types of display media.

Signal Data Signature detection, characterization and classification is the task of recognizing a source signal data signature and its respective temporal parameters within a source signal data stream or recording. Sound Event Detection (SED) is an example of signal data signature detection with many different applications. SED is the task of recognizing sound events and their respective temporal start and end time in an audio recording. SED aims at processing the continuous acoustic signal and converting it into symbolic descriptions of the corresponding sound events as well as the timing of those events. SED and other signal data signature detection algorithms may include context-based indexing, retrieval in multimedia databases, unobtrusive monitoring in health care, surveillance, and medical diagnostics.

The application of signal data signature detection as a medical diagnostic or screening tool is particularly attractive as it represents a non-intrusive, real-time diagnostic that can be essential during public health crisis. Public health situations may be exacerbated by the lack of real-time testing diagnostics which in turn compromises the safety of vulnerable populations. Further, the ability to identify a signal data signature diagnostic of a particular condition or disease can have significant benefits for limiting the spread of and recovery from an infectious disease.

Generally, the system may perform signal data signature detection on a signal data signature recording using a compendium of signal data signature classifiers that have been trained using a ML-derived blueprint for signal data signature classifiers using paired signal data signature and respiratory condition dataset. The signal data signature detection system receives input paired signal data signature data and a corresponding label that indicates the presence or absence of a medical condition. The signal data signature detection system includes of computer hardware that when executed by a processor performs the following steps: 1) splits the paired signal data signature dataset into a training, testing, and validation datasets; 2) defines the model defines unique class boundaries for each class within the paired training signal data signature dataset; 3) utilizes the natural boundaries within the paired training signal data signature dataset to define a source and target models such that the source model will be developed with the entire training dataset and the target models will be developed with subsets of the paired signal data signature training dataset; 4) signal data signature classifier techniques such as feature extractors, weight-adjustment, and tuning layers will be applied to the target models; 5) target models and source model will be tuned using the paired testing signal data signature dataset; 6) the target models and source model will be used as a compendium of signal data signature classifiers on the unseen paired signal data signature testing dataset. The signal data signature detection system includes of input data paired signal data signature recording data with a label and computer hardware that when executed by a processor returns a compendium of signal data signature classifiers, such that when the signal data signature detection system receives another signal data signature recording without a label the signal data signature detection system will return an output label that can be viewed by a hardware display media or paper.

Advantages of the signal data signature detection system are the following 1) can generate a compendium of signal data signature classifiers from data, 2) can generate a compendium of signal data signature classifiers that can be used to predict a label from an unlabeled signal data signature recording, 3) generates signal data signature classifiers that can be used to diagnose acute and/or chronic conditions.

The details of one or more embodiments of the subject matter of this specification are set forth in the accompanying drawings and the description below. Other features, aspects, and advantages of the subject matter will become apparent from the description, the drawings, and the claims.

Systems and methods of illustrative embodiments of the present disclosure include at least one hardware device including a processor and a memory unit, where the memory unit is configured to store a computer program or computer programs created by the physical interface on a temporary basis. The computer program, when executed, causes the processor to perform steps to: receive a signal data signature recording from at least one data source; where the memory unit is configured to store the data sources created by the physical interface on a temporary basis; receive a dataset of labeled signal data signature recordings including signal data signature recording labels; where the memory unit is configured to store the signal data signature recording and dataset of labeled signal data signature recordings created by the physical interface on a temporary basis; identify, using at least one machine learning model, boundaries within the dataset of labeled signal data signature recordings; classify the signal data signature recording to produce an output label using a compendium of signal data signature classifiers based on the boundaries within the dataset of labeled signal data signature recordings; determine an output type of the signal data signature recording; and display the output label on a display media.

### BRIEF DESCRIPTION OF THE DRAWINGS

FIG. 1A, FIG. 1B, FIG. 1C, FIG. 1D, FIG. 1E and FIG. 1F illustrate a signal data signature detection system in accordance with aspects of embodiments of the present disclosure.

FIG. 2 illustrates a machine learning derived boundaries in accordance with aspects of embodiments of the present disclosure.

FIG. 3 illustrates a signal data signature classifier system in accordance with aspects of embodiments of the present disclosure.

FIG. 4 depicts a block diagram of an exemplary computer-based system and platform 400 in accordance with one or more embodiments of the present disclosure.

FIG. 5 depicts a block diagram of another exemplary computer-based system and platform 500 in accordance with one or more embodiments of the present disclosure.

FIG. 6 illustrates schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

FIG. 7 illustrates schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

Drawings - - - Reference Numerals

| | |
|---|---|
| 100 Signal data signature | 101 Signal data signature |
| Detection System | Recording |
| 102 Hardware | 103 Computer |
| 104 Memory | 105 Processor |
| 106 Network Controller | 107 Network |
| 108 Data Sources | 109 Software |
| 110 Signal data signature | 111 Signal data signature |
| Detector System | Classifier System |
| 112 Signal data signature | 113 ML models |
| classifier System | |
| 114 Boundaries | 121 Target model(s) |
| 116 Source model | 117 Knowledge transfer |
| 118 Signal data signature & Signal data | 119 Display Screen |
| signature Type | |
| 120 Paper | 121 Compendium of Signal data |
| | Signature |
| | Classifiers |
| 200 Microphone | 201 .Wav file |
| 202 Signal data signature | 203 Feature Extraction |
| Pre-processing | |
| 204 Symptoms | 205 Medical History |
| 206 Feature Vector | 207 Ensemble of n Classifiers |
| 300 Task 1, T1 | 301 Task 2, T2 |
| 302 Task 3, T3 | 303 Source Data |
| 304 Source Model | 305 Target Data |
| 306 Target Labels | |

### DETAILED DESCRIPTION

### Signal Data Signature Detection System

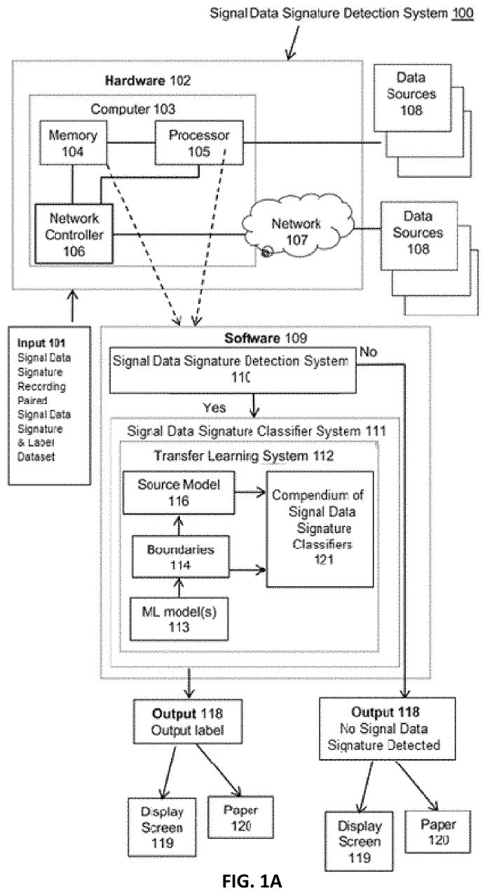

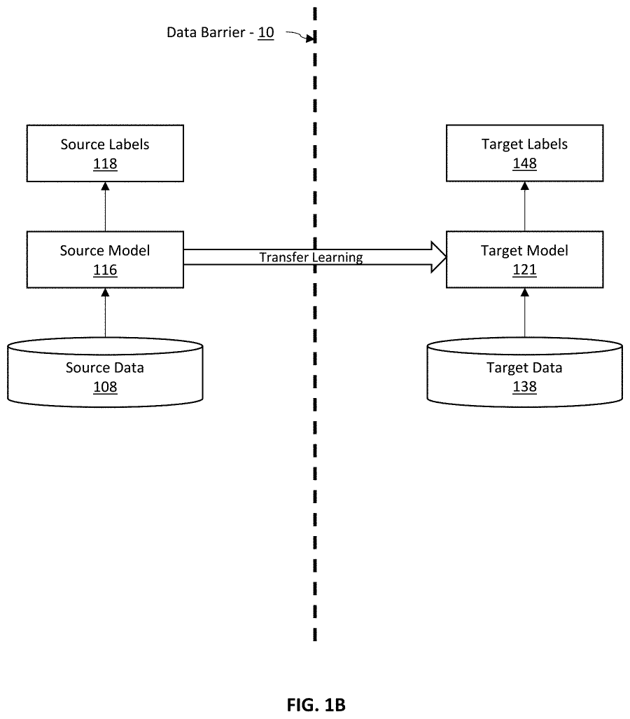

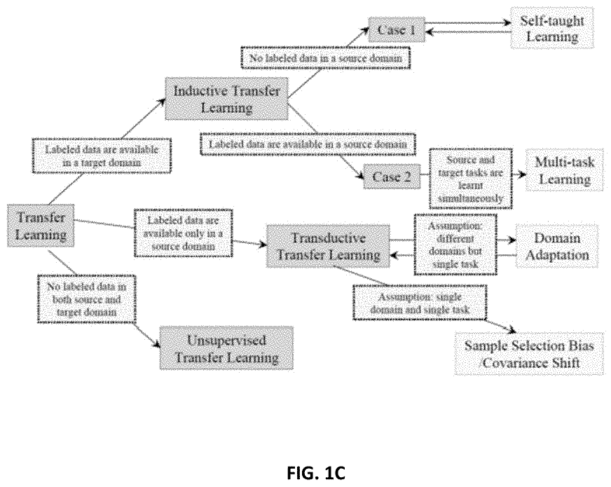

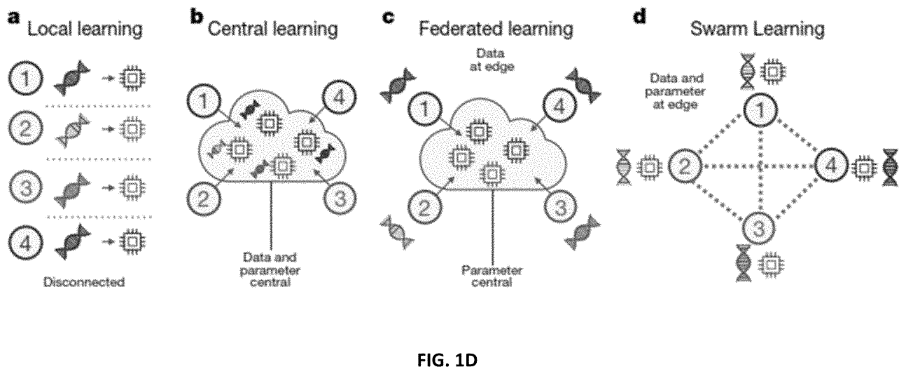

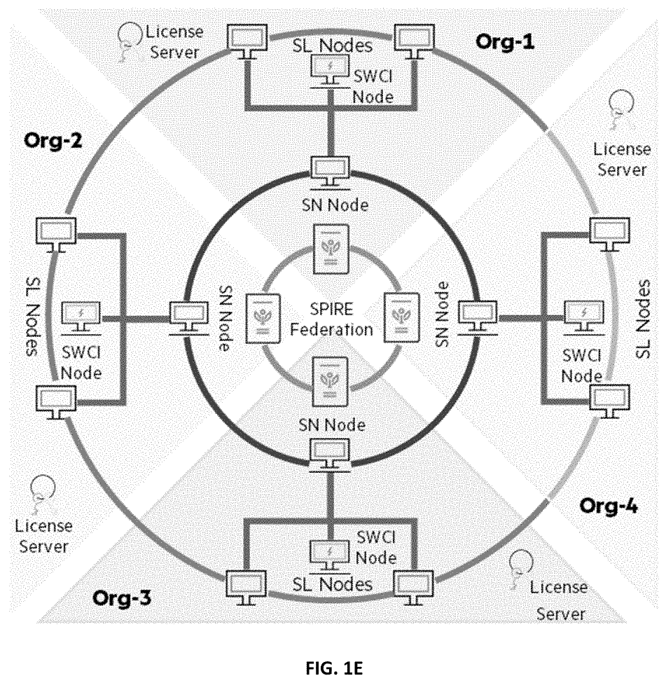

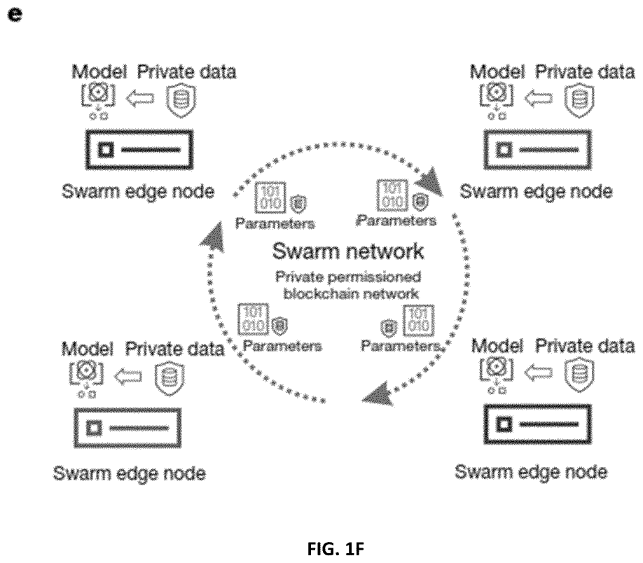

FIGS. 1 through 7 illustrate systems and methods of signal data signature detection and machine learning model training. The following embodiments provide technical solutions and/or technical improvements that overcome technical problems, drawbacks and/or deficiencies in the technical fields involving model training and machine learning techniques for efficient use of data in the presence of data barriers. As explained in more detail, below, technical solutions and/or technical improvements herein include aspects of improved machine learning model training utilizing-federated data, machine learning and swarm learning for a derived strategic blueprint facilitating machine learning across data boundaries. Based on such technical features, further technical benefits become available to users and operators of these systems and methods. Moreover, various practical applications of the disclosed technology are also described, which provide further practical benefits to users and operators that are also new and useful improvements in the art.

The present disclosure relates generally to machine learning classifiers. Embodiments of the present disclosure include signal data signature detection, signal data signature classification, utilizing-a strategic machine learning as a method and system for use of federated data, machine learning and swarm learning for a derived strategic blueprint facilitating machine learning across data boundaries. In some embodiments, the derived strategic blueprint is formed from a compendium of signal data signature classifiers from training data whereby a signal data signature classifier is used based on the natural decision boundaries within the signal data signature that exchange data across data boundaries by using deep learning, transfer learning to exchange model features and Swarm learning to disseminate these model features to multiple instances of the same AI/ML ensembles.

Many sources for data boundaries that impede the use of data to train machine learning models may exist. For example, in data localization, countries impose requirements for organizations to use local data storage or technology, which prevents communicating the data beyond a particular locale and create unnecessary duplication and cost. The use of transfer learning for cross border flow of model features without cross border data flow provides a solution and principle that mitigate these risks without restricting the benefits of machine learning.

In some embodiments, a technical solution may include to classify and tag signal data signatures from datasets then flow the model features derived by AI/ML Deep Learning across data borders using Transfer Learning. In some embodiments, the technical solution may be accomplished with a signal data signature detection system that includes of hardware devices (e.g., desktop, laptop, servers, tablet, mobile phones, etc.), storage devices (e.g., hard drive disk, floppy disk, compact disk (CD), secure digital card, solid state drive, cloud storage, etc.), delivery devices (paper, electronic display), a computer program or plurality of computer programs, and a processor or plurality of processors. A signal data signature detection system when executed on a processor (e.g., CPU, GPU) would be able to identify a specific signal data signature from other types of signal data signatures and delivered to clinicians and/or end-users through a delivery device (paper, electronic display). The model features derived from the signal data signatures flow across data boundaries using transfer learning.

The free and efficient flow of data allows machine learning models and other data analytics solutions to access the global range and quality of services, and permits such data analytics solutions to more efficiently leverage the analysis from across data barriers while overcoming technical hurdles with accessing data. For example:
Services can emerge and be adopted in one national market, then expand readily to other markets, bringing benefits for consumers and businesses.
Startup businesses can have a global reach from Day One by establishing an internet presence that is simultaneously national and international.
Internet infrastructure suppliers, such as cloud computing providers and mobile operators, can structure their services to serve large numbers of clients in multiple markets without exporting local data.
Software platforms can scale up (and down) in development, making direct or indirect use of cloud and Software-as-Medical-Device (SaMD) providers.

In some embodiments, a Data Management (MDM) architectural model may help bridge a gap among organizations, technologies, and users that results from data barriers. Enterprise Data Management, an IT discipline, is composed of a set of tools and processes to define enterprise data entities of an organization. Enterprise data management objectives are to organize and manage the organization's enterprise data. In some embodiments, the MDM may include an architectural type including, e.g., Centralized, Federated or a combination thereof.

In some embodiments, in a Centralized Data Model (CDM), data may be consolidated in one repository. Using CDM may resolve data duplications, inconsistent master data, and improve data quality. However, implementing CDM may require users to overcome challenges such as crossing data barriers, geographical locations of the applications, cost of the implementation, and compliance with privacy rules and regulations.

In some embodiments, a Federated Data Model (FDM) may enable an organization to extend data and business services to inquire data from multiple sources. An FDM may make data available to all users and/or partners of an organization. Yet, implementing FDM comes with many challenges such as data barriers, synchronization of data between transactional and master data, network connectivity between the sources and MDM hub, privacy rules and regulations, performance, maintenance, and identifying roles and responsibilities.

In some embodiments, AI/ML model features derived from Centralized Data and/or Federated Data is not subject to cross border data flow restrictions because the AI/ML model features are the product of the AI/ML Deep Learning processing of the source data and no longer contains the source data itself. Similarly, the AI/ML model features contain no personal data or identifiers and therefore is not subject to cross border data flow data privacy rules or regulations. Additionally, the movement of the AI/ML model features may provide network and storage efficiencies that would not be possible with transferring training data, which may include much larger quantities of data.

Determining which architectural model is suitable for a particular platform depends on several factors; including use of the platform data, number of applications (domains) that will use the master data, derivation of model features, cross border data flow rules and regulations, development and availability costs, delivery schedule, performance, efficiency, limitations, risk, training, operations, compliances, deployment, security, accessibility, dependability, data quality, stability, maintainability, reliability, availability, flexibility, scalability, predictability and cross border data privacy rules and regulations.

FIG. 1A illustrates a signal data signature detection system 100 with the following components: input 101, hardware 102, software 109, and output 118. The input is a signal data signature recording such as a signal data signature recording captured by a sensor, a signal data signature recording captured on a mobile device, and a signal data signature recording captured on any other device, among others. The input 101 may be provided by an individual, individuals or a system and recorded by a hardware device 102 such as a computer 103 with a memory 104, processor 105 and or network controller 106. A hardware device is able to access data sources 108 via internal storage or through the network controller 106, which connects to a network 107.

In some embodiments, the signal data signature detection system 100 may identify a classification label that indicates the presence or absence of a disease when the system is provided with unbalanced paired signal data signature recordings and their corresponding disease labels and another unlabeled signal data signature recording. These embodiments are advantageous for identifying classification labels such as, e.g., underlying respiratory illnesses for providing in-home, easy to use diagnostics for respiratory conditions, such as, e.g., COVID-19, bronchitis, pneumonia, among others or any combination thereof.

In some embodiments, in order to achieve a software program that is able, either fully or partially, to detect and diagnose signal data signatures, that program generates a compendium of signal data signature classifiers 121 from a training dataset. Another challenge is that such a program must be able to scale and process large datasets.

Embodiments of the present disclosure are directed to the signal data signature detection system 100 whereby a signal data recording (the input 101) is provided by an individual or individuals(s) or system into a computer hardware whereby labeled data sources and unlabeled data source(s) are stored on a storage medium and then the labeled data sources and unlabeled data source(s) are used as input to a computer program or computer programs which when executed by a processor(s) provides compendium of signal data signature classifiers 121 saved to a hardware device as executable source code such that when executed by a processor(s) with an unlabeled data source(s) generates an output label(s) (the output 118) which is shown on a hardware device such as a display screen or sent to a hardware device such as a printer where it manifests as physical printed paper that indicates the diagnosis of the input signal data recording and signal data signature.

In some embodiments, the data sources 108 that are retrieved by a hardware device 102 in one of other possible embodiments includes for example but not limited to: 1) imbalanced paired training dataset of signal data signature recordings and labels and unlabeled signal data signature recording, 2) balanced paired training dataset of signal data signature recordings and labels and unlabeled signal data signature recording, 3) imbalanced paired training dataset of video recordings and labels and unlabeled video recording, 4) imbalanced paired training dataset of video recordings and labels and unlabeled signal data signature recording, 5) paired training dataset of signal data signature recordings and labels and unlabeled video recording. In some embodiments, a “balanced” training dataset may include an equal number of training signal data signature records for each classification, such as equal numbers of training data for each of a first classification and for a second classification in a binary classification, such as, e.g., a positive and a negative classification in a diagnosis classification. In some embodiments, an “imbalanced” training dataset may include an unequal number of training signal data signature records for a first classification and for a second classification in a binary classification, such as, e.g., a positive and a negative classification in a diagnosis classification. Example ratios for an imbalanced training dataset may include, e.g., 70:30, 50:25:25, 60:40, 60:20:20, or any other suitable ratio. Such a training scheme influences the training, machine learning and probability predictions of the classifiers trained with the balanced and/or unbalanced SDS data sets. Unbalanced sets tend to bias the ML towards the higher ratio SDS as a prediction where balanced sets tend to bias towards more equal probabilities.

In some embodiments, the data sources 108 and the signal data signature recording input 101 are stored in memory or a memory unit 104 and passed to a software 109 such as computer program or computer programs that executes the instruction set on a processor 105. The software 109 being a computer program executes a signal data signature detector system 110 and a signal data signature classification system 111. The signal data signature classification system 111 executes a signal data signature classifier system 112 on a processor 105 such that the paired training dataset is used to train machine learning (ML) models 113 that generate boundaries within the dataset 114 whereby the boundaries inform the scope and datasets of target model(s) 121 and the source model 116, such that knowledge is transferred 117 from the source model 116 to the target model(s) 121.

In some embodiments, the boundaries may include thresholds set for determination of a diagnosis based on the classifier predictions. For example, if the predictions from the classifier span 0.001 (not COVID) to 0.999 (IS COVID) then thresholds (boundaries) are used to determine the lower limit for IS COVID prediction values, such as, 0.689, above which the diagnosis is COVID. While a NOT COVID prediction value threshold (boundary), say 0.355 defines the limit below which the diagnosis is no COVID disease. Between the boundaries (0.3551 to 0.6889) is indeterminant. In some embodiments, the thresholds may be learned via the training of the ML models 113, experimentally determined, or determined by any other suitable technique. The positive diagnosis boundary may include, e.g., between 0.400 and 0.499, between 0.500 and 0.599, between 0.600 and 0.699, between 0.700 and 0.799, between 0.800 and 0.899, between 0.900 and 0.999, for example 0.680, 0.681, 0.682, 0.683, 0.684, 0.685, 0.686, 0.687, 0.688, 0.689, 0.690, 0.691, 0.692, 0.693, 0.694, 0.695, 0.696, 0.697, 0.698, 0.699, 0.700, etc. The negative diagnosis boundary may include, e.g., between 0.100 and 0.199, between 0.200 and 0.299, between 0.300 and 0.399, between 0.400 and 0.499, for example 0.350, 0.351, 0.352, 0.353, 0.354, 0.355, 0.356, 0.357, 0.358, 0.359, 0.360, 0.361, 0.362, 0.363, 0.364, 0.365, 0.366, 0.367, 0.368, 0.369, 0.370, etc. The signal data signature classifier system 112 defines the boundaries and scope of target model(s) 121 and source model 116 whereby knowledge is transferred 117 from the source model 116 that has been trained on a larger training dataset to the target model(s) 121 that are trained on a smaller training dataset. In some embodiments, the output 118 is a label that indicates the presence or absences of a condition given that an unlabeled signal data signature recording is provided as input 101 to the signal data signature detection system such that the output 118 can be viewed by a reader on a display screen 119 or printed on paper 120.

In some embodiments, the signal data signature detection system 100 hardware 102 includes the computer 103 connected to the network 107. The computer 103 is configured with one or more processors 105, a memory or memory unit 104, and one or more network controllers 106. In some embodiments, the components of the computer 103 are configured and connected in such a way as to be operational so that an operating system and application programs may reside in a memory or memory unit 104 and may be executed by the processor or processors 105 and data may be transmitted or received via the network controller 106 according to instructions executed by the processor or processor(s) 105. In some embodiments, a data source 108 may be connected directly to the computer 103 and accessible to the processor 105, for example in the case of a signal data signature sensor, imaging sensor, or the like. In some embodiments, a data source 108 may be executed by the processor or processor(s) 105 and data may be transmitted or received via the network controller 106 according to instructions executed by the processor or processors 105. In one embodiment, a data source 108 may be connected to the signal data signature classifier system 112 remotely via the network 107, for example in the case of media data obtained from the Internet. The configuration of the computer 103 may be that the one or more processors 105, memory 104, or network controllers 106 may physically reside on multiple physical components within the computer 103 or may be integrated into fewer physical components within the computer 103, without departing from the scope of the present disclosure. In one embodiment, a plurality of computers 103 may be configured to execute some or all of the steps listed herein, such that the cumulative steps executed by the plurality of computers are in accordance with the present disclosure.

In some embodiments, a physical interface is provided for embodiments described in this specification and includes computer hardware and display hardware (e.g., the display screen of a mobile device). In some embodiments, the components described herein may include computer hardware and/or executable software which is stored on a computer-readable medium for execution on appropriate computing hardware. The terms “computer-readable medium” or “machine readable medium” should be taken to include a single medium or multiple media that store one or more sets of instructions. The terms “computer-readable medium” or “machine readable medium” shall also be taken to include, but not be limited to, solid-state memories, and optical and magnetic media. For example, “computer-readable medium” or “machine readable medium” may include Compact Disc Read-Only Memory (CD-ROMs), Read-Only Memory (ROMs), Random Access Memory (RAM), and/or Erasable Programmable Read-Only Memory (EPROM). The terms “computer-readable medium” or “machine readable medium” shall also be taken to include any non-transitory storage medium that is capable of storing, encoding or carrying a set of instructions for execution by a machine and that cause a machine to perform any one or more of the methodologies described herein. In other embodiments, some of these operations might be performed by specific hardware components that contain hardwired logic. Those operations might alternatively be performed by any combination of programmable computer components and fixed hardware circuit components.

In one or more embodiments of the signal data signature classifier system 111 software 109 includes the signal data signature classifier system 112 which will be described in detail in the following section.

In one or more embodiments of the signal data signature detection system 100 the output 118 includes a strongly labeled signal data signature recording and identification of signal data signature type. An example would be signal data signature sample from a patient which would include: 1) a label of the identified signal data signature type, 2) or flag that tells the user that a signal data signature was not detected. The output 118 of signal data signature type or message that a signal data signature was not detected will be delivered to an end user via a display medium such as but not limited to a display screen 119 (e.g., tablet, mobile phone, computer screen) and/or paper 120.

In some embodiments, the label produced by the signal data signature classifier system 111 may include a start time, an end time or both of a segment an audio recording of the input 101. In some embodiments, the signal data signature classifier system 111 may be trained to identify a modified audio recording in the signal data signature recording 101 based on a matching to a target distribution. In some embodiments, the modified signal data signature recording may include a processing that extracts segments of the audio recording. For example, the signal data signature classifier system 111 may identify, e.g., individual coughs in a recording of multiple coughs, and extract a segment for each cough having a start time label at a beginning of each cough and an end time label at an end of each cough. In some embodiments, the audio recording may be a single cough, and the signal data signature classifier system 111 may label the start time and the end time of the single cough to extract the segment of the audio recording having the cough.

### Signal Data Signature Classifier System

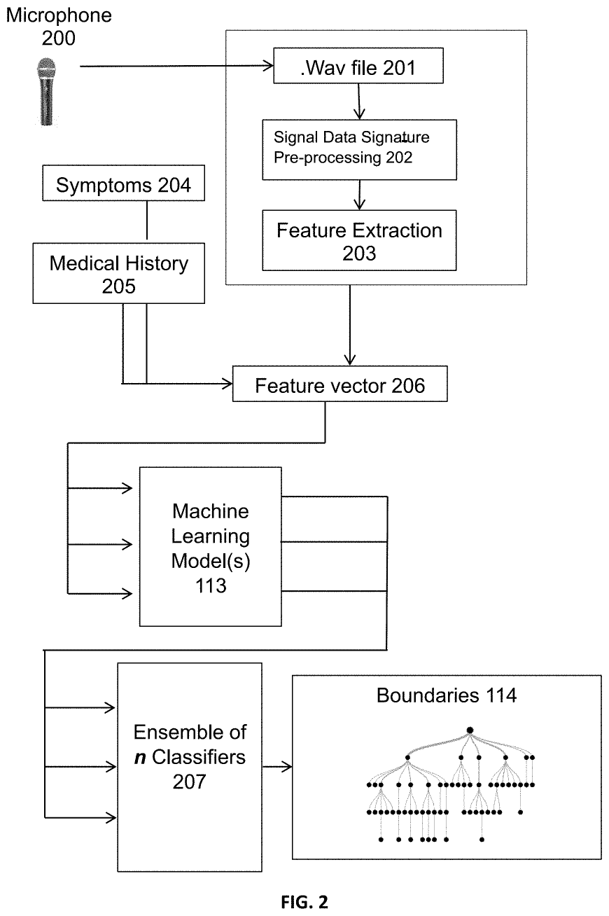

In some embodiments, a signal data signature classifier system 112 with real-time training of machine learning models 113 and the real-time training of model(s) 121 and the source model 116, hardware 102, software 109, and output 118. FIG. 2. illustrates an input to the signal data signature classifier system 112 that may include but is not limited to paired training dataset of signal data signature recordings and corresponding signal data signature labels and an unpaired signal data signature recording 101 that is first received and processed as a signal data signature wave by a hardware device such as a microphone 200. In addition, the signal data signature labels may be input into the signal data signature classifier system using a physical hardware device such as a keyboard.

In some embodiments, the signal data signature classifier system 112 uses a hardware 102, which includes of a memory or memory unit 104, and processor 105 such that software 109, a computer program or computer programs is executed on a processor 105 and trains in real-time a set of signal data signature classifiers. The output from signal data signature classifier system 112 is a label 118 that matches and diagnosis a signal data signature recording file. A user is able to the signal data signature type output 118 on a display screen 119 or printed paper 120.

In some embodiments, the signal data signature classifier system 112 may be configured to utilize one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
a. define Neural Network architecture/model,
b. transfer the input data to the exemplary neural network model,
c. train the exemplary model incrementally,
d. determine the accuracy for a specific number of timesteps,
e. apply the exemplary trained model to process the newly-received input data,
f. optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

In some embodiments, training the set of signal data signature classifiers may include transfer learning to share model features amongst the signal data signature classifiers in the set of signal data signature classifiers. In some embodiments, the model features may include, e.g., Fast Formant Transform spectrogram, MEL spectrogram, MFCC Spectrogram, as well as specific spectrum features such as formant configuration or formant slurring, among other features or any combination thereof.

As illustrated FIG. 1B, a source model including the signal data signature classifier model 116 may output source labels 118 based on a large set of source data 108. Through transfer learning, learned features of the source model 116 may be provided across a data barrier 10 to a target model in the compendium of source signal data classifiers 121. As a result, the target model 121 may output target labels 148 based on the transfer learning using the learned features and a smaller set of local target data 138, thus preserving privacy, confidentiality, network resources and storage resources while transferring model learned across a data barrier 10. In some embodiments, the transfer learning of learned features may include a transfer of internal neural network connections rather than the data used to train the connections, thus preserving the privacy of the data and complying with, e.g., data boundaries and other data barriers.

In some embodiments, there may be different transfer learning strategies and techniques, which can be applied based on the domain, task at hand, and the availability of data. Thus, transfer learning methods can be categorized based on the type of traditional ML algorithms involved, such as:
Inductive Transfer learning: In this scenario, the source and target domains are the same, yet the source and target tasks are different from each other. The algorithms try to utilize the inductive biases of the source domain to help improve the target task. Depending upon whether the source domain contains labeled data or not, this can be further divided into two subcategories, similar to multitask learning and self-taught learning, respectively.
Unsupervised Transfer Learning: This setting is similar to inductive transfer itself, with a focus on unsupervised tasks in the target domain. The source and target domains are similar, but the tasks are different. In this scenario, labeled data is unavailable in either of the domains.
Transductive Transfer Learning: In this scenario, there are similarities between the source and target tasks, but the corresponding domains are different. In this setting, the source domain has a lot of labeled data, while the target domain has none. This can be further classified into subcategories, referring to settings where either the feature spaces are different or the marginal probabilities.

The three transfer categories discussed in the previous section outline different settings where transfer learning can be applied, and studied in detail. To answer the question of what to transfer across these categories, some of the following approaches can be applied:
Instance transfer: In some embodiments, one or more signal data signature classifiers may reuse knowledge from a source domain for a target task. In some embodiments, “knowledge” of the classifier may include, e.g., internal neural network connections that compose and define the hidden layers of the classifiers. Thus, the instance transfer may include a transfer of internal neural network connections. In most cases, the source domain data cannot be reused directly. Rather, there are certain instances from the source domain that can be reused along with target data to improve results. In case of inductive transfer, modifications such as AdaBoost, which may help utilize training instances from the source domain for improvements in the target task.
Feature-representation transfer: In some embodiments, feature representation transfer may minimize domain divergence and reduce error rates by identifying “good” feature representations that can be utilized from the source domain to target domains, where “good” refers to a signal data signature characteristics that are specific and/or unique to a specific disease state and/or health state. Depending upon the availability of labeled data, supervised or unsupervised methods may be applied for feature-representation-based transfers.
Parameter transfer: This approach works on the assumption that the models for related tasks share some parameters or prior distribution of hyperparameters. Unlike multitask learning, where both the source and target tasks are learned simultaneously, for transfer learning, we may apply additional weightage to the loss of the target domain to improve overall performance.
Relational-knowledge transfer: Unlike the preceding three approaches, the relational-knowledge transfer attempts to handle non-IID data, such as data that is not independent and identically distributed. In other words, data, where each data point has a relationship with other data points; for instance, social network data utilizes relational-knowledge-transfer techniques.

FIG. 1C, FIG. 1D and the following table summarizes the relationship between different transfer learning strategies and what to transfer.

| | Inductive | Transductive | Unsupervised |
|---|---|---|---|
| | Transfer | Transfer | Transfer |
| | Learning | Learning | Learning |
| Instance-transfer | ✓ | ✓ | |
| Feature-representation-transfer | ✓ | ✓ | ✓ |
| Parameter-transfer | ✓ | | |
| Relational-knowledge-transfer | ✓ | | |

These strategies are general approaches which can be applied towards machine learning techniques. In some embodiments, transfer learning may be applied in the context of deep learning models, which may represent inductive learning. In some embodiments, the objective for inductive-learning algorithms is to infer a mapping from a set of training examples. For instance, in cases of classification, such as signal data classification, the model learns mapping between input features and class labels. In order for such a learner to generalize well on unseen data, its algorithm works with a set of assumptions related to the distribution of the training data. These sets of assumptions are known as inductive bias. The inductive bias or assumptions can be characterized by multiple factors, such as the hypothesis space it restricts to and the search process through the hypothesis space. Thus, these biases impact how and what is learned by the model on the given task and domain.

In some embodiments, inductive transfer techniques may utilize the inductive biases of the source task to assist the target task, such as by adjusting the inductive bias of the target task by limiting the model space, narrowing down the hypothesis space, or making adjustments to the search process itself with the help of knowledge from the source task. In some embodiments, inductive-learning algorithms may also utilize Bayesian and Hierarchical transfer techniques to assist with improvements in the learning and performance of the target task.

Deep learning has made considerable progress in recent years. This has enabled us to tackle complex problems and yield amazing results. However, the training time and the amount of data required for such deep learning systems are much more than that of traditional ML systems. Accordingly, in some embodiments, one or more pre-trained deep learning networks with state-of-the-art performance that have been developed and tested across domains may form the basis of transfer learning in the context of deep learning, or deep transfer learning. In some embodiments, the sound signal data classifiers may thus take advantage of the cross-domain deep learning network(s) via transfer learning. The transfer learning process can leverage the training of the pre-trained deep learning network across a data barrier provide training for the sound signal data classifiers without the need for large training data sets.

AI-based solutions rely intrinsically on appropriate algorithms, but even more so on large training datasets. As medicine is inherently decentral, the volume of local data is often insufficient to train reliable classifiers. As a consequence, centralization of data is one model that has been used to address the local limitations. While beneficial from an AI perspective, centralized solutions have inherent disadvantages, including increased data traffic and concerns about data ownership, confidentiality, privacy, security and the creation of data monopolies that favor data aggregators. Consequently, solutions to the challenges of central AI models must be effective, accurate and efficient; must preserve confidentiality, privacy and ethics; and must be secure and fault-tolerant by design. Federated AI addresses some of these aspects. Data are kept locally and local confidentiality issues are addressed, but model parameters are still handled by central custodians, which concentrates power.

Furthermore, such star-shaped architectures decrease fault tolerance. In some embodiments, partially and/or completely decentralized AI solutions may overcome current shortcomings, and accommodate inherently decentral data structures and data privacy and security regulations in medicine. In some embodiments, integration of the signal data signature classifier system in a federated learning architecture may:
1) keep large medical data locally with the data owner;
2) require no exchange of raw data, thereby also reducing data traffic and preventing cross border data flow;
3) provide high-level data security;
4) guarantee secure, transparent and fair onboarding of decentral members of the network without the need for a central custodian;
5) allow parameter merging with equal rights for all members; and
6) protect machine learning models from attacks.

In some embodiments, the federated learning architecture of the signal data signature classifier system 111 may include Swarm Learning (SL), which combines decentralized hardware infrastructures, distributed machine learning based on standardized AI engines with a permissioned blockchain to securely onboard members, to dynamically elect the leader among members, and to merge model parameters. Computation is orchestrated by an SL library (SLL) and an iterative AI learning procedure that uses decentral data (Supplementary Information).

FIG. 1E and FIG. 1F illustrates a Swarm Learning architecture for cross-barrier learning in accordance with one or more embodiments of the present disclosure.

In some embodiments, Swarm Learning is a decentralized, privacy-preserving Machine Learning framework. This framework utilizes the computing power at, or near, the distributed data sources to run the Machine Learning algorithms that train the models. It uses the security of a blockchain platform to share learnings with peers in a safe and secure manner. In Swarm Learning, training of the model occurs at the edge, where data is most recent, and where prompt, data-driven decisions are mostly necessary. In this completely decentralized architecture, only the insights learned are shared with the collaborating ML peers, not the raw data. This tremendously enhances data security and privacy. In FIG. 1 of Swarm Learning, Org-1 through Org-4 represent four separate installations of the same or related AI/ML Deep learning neural networks in four separate national regions with cross border data flow restrictions and disparate data privacy rules and regulations. SPIRE Federation represents the deep learning model features derived from the Federated and/or Centralized Data in each national region. The SPIRE Federation employs deep learning transfer to synchronize the deep learning model features across the four national regions (ORG-1 through ORG-4):

In some embodiments, Swarm Learning may include five components, connected to form a network:
Swarm Learning (SL) nodes—These nodes run a user-defined Machine Learning algorithm. This algorithm is called the Swarm Learning ML Program. The Swarm Learning ML Program program is responsible for training and updating the model in an iterative fashion. In some embodiments, the Swarm Learning ML program may be a Keras (TensorFlow 2 backend) or PyTorch based Machine Learning algorithm that is implemented using Python3, or any other suitable tooling for the machine learning algorithm.
Swarm Network (SN) nodes—In some embodiments, these nodes form the blockchain network. In some embodiments, the Swarm Network nodes interact with each other using the blockchain platform to maintain global state information about the model that is being trained and to track progress (note that only metadata is written to the blockchain. The model itself is not stored in the blockchain.) In some embodiments, tSwarm Network nodes use this state and progress information to coordinate the working of the Swarm Learning nodes. Each Swarm Learning node registers itself with a Swarm Network node as a part of its startup and initialization.
Sentinel node: In some embodiments, the is a special Swarm Network node. The Sentinel node is responsible for initializing the blockchain network and may be the first node to start.
Swarm Learning Command Interface node (SWCI)—In some embodiments, the SWCI node is the command interface tool to the Swarm Learning framework. In some embodiments, the SWCI node may be used to view the status, control and manage the swarm learning framework. In some embodiments, the SWCI may use a secure link to connect to the Swarm Network node, using the application programming interface (API) port. In some embodiments, the SWCI node can connect to any of the SN nodes in a given Swarm Learning framework to manage the framework.
Server nodes—In some embodiments, the server nodes provide the security for the whole network. In some embodiments, the platform may run one or more Server nodes that are connected together to form a federation. In some embodiments, the platform includes an Agent Workload Attestor plugin (not shown in the figure) that communicates with the Servers to attest the identities of the Swarm Network and Swarm Learning nodes, acquire and manage a Verifiable Identity Document (VID).
License Server node—In some embodiments, the license to run the Swarm Learning platform is installed and managed by the License Server node.

In some embodiments, Swarm Learning nodes works in collaboration with other Swarm Learning nodes in the network. In some embodiments, each swarm learning node regularly shares its deep transfer learning model features with the other nodes and incorporates their insights. This process continues until the Swarm Learning nodes train the model to desired state.

FIG. 2 depicts a partial view of the signal data signature classifier system 112 with an input signal data signature recording 101 captured using a physical hardware device, microphone 200; such that the signal data signature signal is captured as a .wav file 201, or any other type of computer readable signal data signature signal formatted file, and is then pre-processed 202. Signal Data Signature Pre-Processing 202 imposes a few, basic standards upon the sample. This filter acts to address three quality-centric concerns, specifically; Stereo to Mono Compatibility, Peak Input Loudness Level, and Attenuation of Unrelated Low Frequencies.

In some embodiments, the first function of the filter which addresses Stereo to Mono Compatibility, combines the two channels of stereo information into one single mono representation. This ensures that only a single perspective of the signal is being considered or analyzed at one time.

In some embodiments, once the signal is summed to mono, it is then normalized, and brought up to its loudest possible peak level while preserving all other spectral characteristics of the source; including frequency content, dynamic range as well as the signal to noise ratio of the sound.

Finally, in some embodiments, the last step is to remove any unwanted low frequency noises that could obscure the analysis of the target sound of the source file. This is achieved by implementing a High Pass Filter, with a Cutoff of 80 hz at a slope of −36 dB/8va (Oct).

In some embodiments, once signal data signature preprocessing is complete, feature extraction algorithms operate on the pre-processed signal data signature file generating feature extraction 203 which along with or without symptoms 204, medical history 205 are feed into a feature vector 206. The feature vector 206 is used as an input to train machine-learning model(s) 113 which result in an ensemble of n classifiers 207. The ensemble of n classifiers is used to define the natural boundaries 114 in the training dataset.

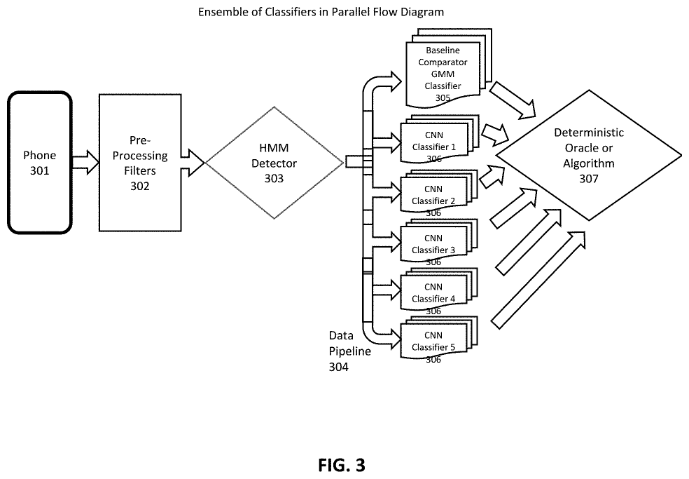

FIG. 3 depicts an illustrative signal data signature classifier system in accordance with aspects of embodiments of the present disclosure. In some embodiments, referring to FIG. 3, the signal data signature is captured by a mobile phone or other mobile device using an app or a web client (301). The signal data signature passes through a pre-processing filter as describer for (202) above and for (302) in this figure. The signal data signature is filtered using a Hidden Markov Model (HMM) help direct signal data signatures (303) to the correct classifiers. The data then flows through a parallel data pipeline (304). The signal data signature is passed to a comparison classifier (305) for the purpose of determining whether or not the submitted signal data signature matches the baseline cluster of signal data signatures for the user. Simultaneously, the data is passed to multiple identical convolutional neural network classifiers (CNN) (306) existing as instances in identical environments trained with randomly selected signal data signatures from a large pool of calibration quality signal data signatures classify the incoming signal data signature (306). The relative probability of a signal data signature matching a signal data signature library in each classifier is passed to a deterministic oracle/algorithm (307) provides a a diagnosis

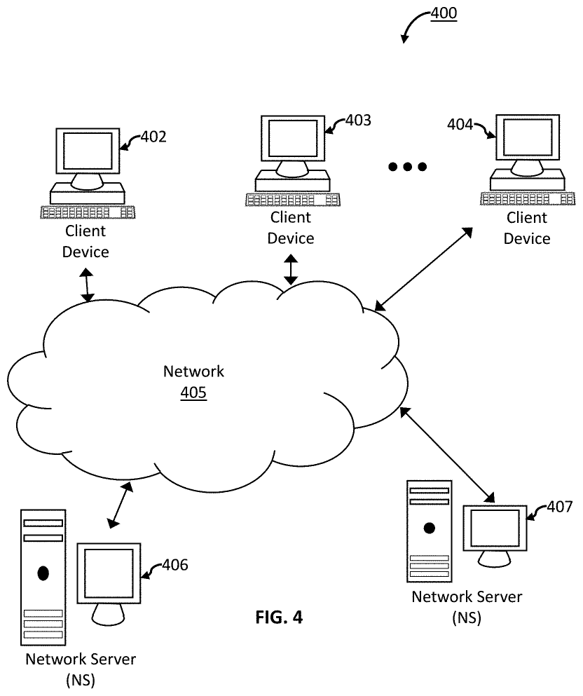

FIG. 4 depicts a block diagram of an exemplary computer-based system and platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 400 may be configured to manage a large number of members and concurrent transactions, as detailed herein. In some embodiments, the exemplary computer-based system and platform 400 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 4, members 402-404 (e.g., clients) of the exemplary computer-based system and platform 400 may include virtually any computing device capable of receiving and sending a message over a network (e.g., cloud network), such as network 405, to and from another computing device, such as servers 406 and 407, each other, and the like. In some embodiments, the member devices 402-404 may be personal computers, multiprocessor systems, microprocessor-based or programmable consumer electronics, network PCs, and the like. In some embodiments, one or more member devices within member devices 402-404 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 402-404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 402-404 may include may run one or more applications, such as Internet browsers, mobile applications, voice calls, video games, videoconferencing, and email, among others. In some embodiments, one or more member devices within member devices 402-404 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java, .Net, QT, C, C++ and/or other suitable programming language. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as network attached storage (NAS), a storage area network (SAN), a content delivery network (CDN) or other forms of computer or machine readable media.

In some embodiments, the exemplary server 406 or the exemplary server 407 may be a web server (or a series of servers) running a network operating system, examples of which may include but are not limited to Microsoft Windows Server, Novell NetWare, or Linux. In some embodiments, the exemplary server 406 or the exemplary server 407 may be used for and/or provide cloud and/or network computing. Although not shown in FIG. 4, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 401-404.

In some embodiments and, optionally, in combination of any embodiment described above or below, for example, one or more exemplary computing member devices 402-404, the exemplary server 406, and/or the exemplary server 407 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

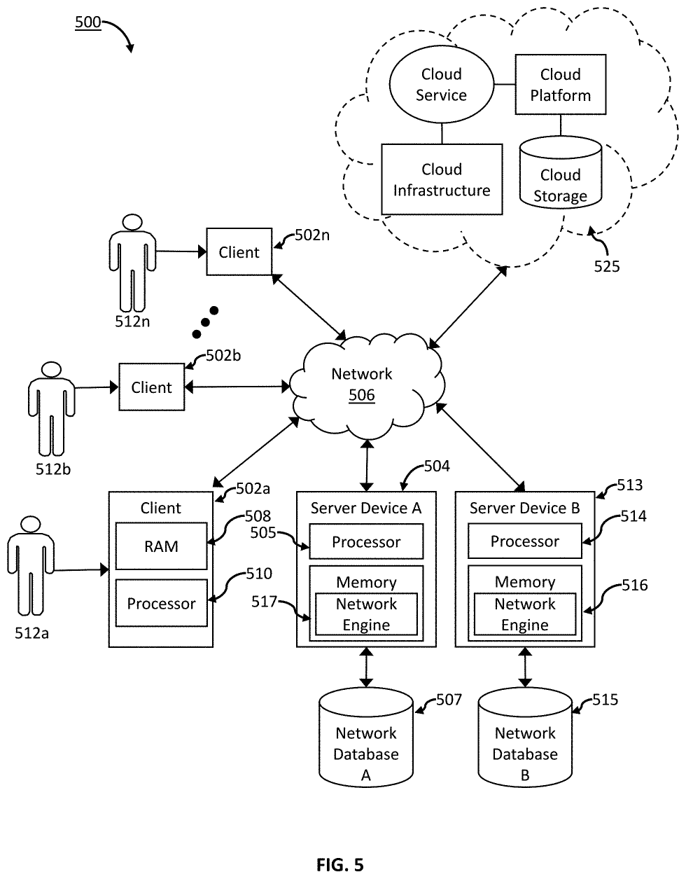

FIG. 5 depicts a block diagram of another exemplary computer-based system and platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 502a, 502b thru 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of client 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 502a through 502n may also comprise a number of external or internal devices such as a mouse, a CD-ROM, DVD, a physical or virtual keyboard, a display, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing devices 502a through 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™ Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, users, 512a through 502n, may communicate over the exemplary network 506 with each other and/or with other systems and/or devices coupled to the network 506. As shown in FIG. 5, exemplary server devices 504 and 513 may be also coupled to the network 506. In some embodiments, one or more member computing devices 502a through 502n may be mobile clients.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

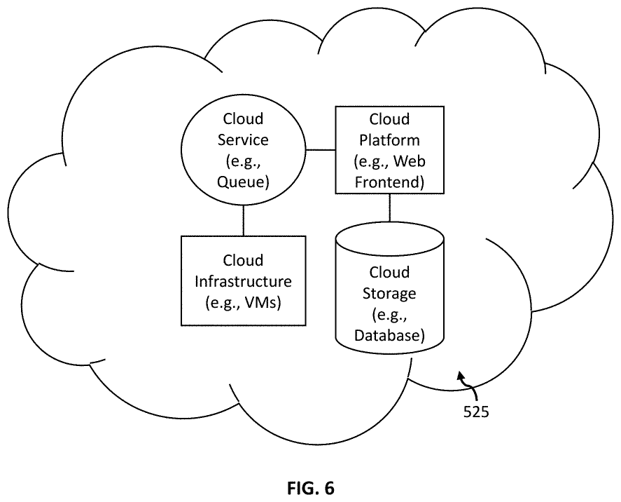

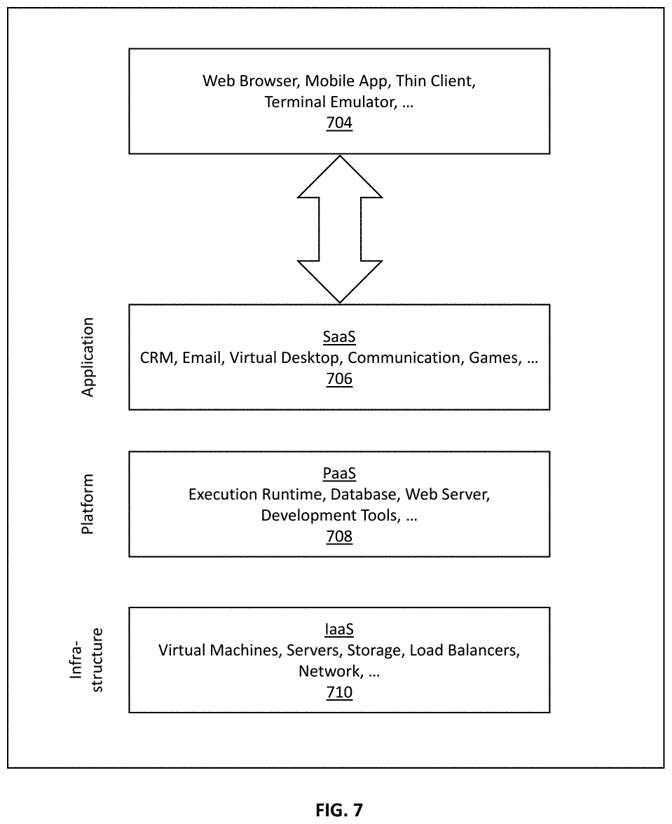

In some embodiments, the exemplary inventive computer-based systems/platforms, the exemplary inventive computer-based devices, and/or the exemplary inventive computer-based components of the present disclosure may be specifically configured to operate in a cloud computing/architecture 525 such as, but not limiting to: infrastructure a service (IaaS) 710, platform as a service (PaaS) 708, and/or software as a service (SaaS) 706 using a web browser, mobile app, thin client, terminal emulator or other endpoint 704. FIGS. 6 and 7 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

The aforementioned examples are, of course, illustrative and not restrictive.

At least some aspects of the present disclosure will now be described with reference to the following numbered clauses.

1. A signal data signature detection system, comprising:
a physical hardware device comprising of a memory unit and processor;
   wherein the memory unit is configured to store a computer program or computer programs created by the physical interface on a temporary basis;
   wherein the computer program, when executed, causes the processor to perform steps to:
      receive a signal data signature recording from at least one data source;
         wherein the memory unit is configured to store the data sources created by the physical interface on a temporary basis;
      receive a dataset of labeled signal data signature recordings including signal data signature recording labels;
         wherein the memory unit is configured to store the signal data signature recording and dataset of labeled signal data signature recordings created by the physical interface on a temporary basis;
      identify, using at least one machine learning model, boundaries within the dataset of labeled signal data signature recordings;
      classify the signal data signature recording to produce an output label using a compendium of signal data signature classifiers based on the boundaries within the dataset of labeled signal data signature recordings;
      determine an output type of the signal data signature recording; and
      display the output label on a display media.

While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A signal data signature detection system, comprising:
a physical hardware device consisting of a memory unit and processor;
wherein the memory unit is configured to store a computer program or computer programs created by the physical interface on a temporary basis;
wherein the computer program, when executed, causes the processor to perform steps to:
receive a signal data signature recording from at least one data source;
receive a dataset of labeled signal data signature recordings;
wherein the dataset of labeled signal data signature recordings comprises a dataset of signal data signature recording labels;
wherein each labeled signal data signature recording of the dataset of labeled signal data signature recordings is associated with at least one signal data signature recording label of the dataset of signal data signature recording labels:
identify, using at least one machine learning model, boundaries within the dataset of labeled signal data signature recordings;
classify the signal data signature recording to produce an output label using the compendium of signal data signature classifiers based on the at least one transfer learning framework;
determine an output type of the signal data signature recording based at least in part on the output label; and
display the output type on a display media.

2. The signal data signature detection system as recited in claim 1, wherein the at least one transfer learning framework comprises a swarm learning framework.

3. The signal data signature detection system as recited in claim 2, wherein each signal data signature classifier in the compendium of signal data signature classifiers is a swarm node in the swarm learning framework.

4. The signal data signature detection system as recited in claim 1, wherein the computer program, when executed, causes the processor to perform steps to:
determine an inductive bias in the dataset of labeled signal data signature recordings based at least in part on the dataset of signal data signature recording labels; and
utilize the at least one transfer learning framework comprising inductive transfer to apply the inductive bias to the compendium of signal data signature classifiers.

5. The signal data signature detection system as recited in claim 1, wherein at least one signal data signature classifiers in the compendium of signal data signature classifiers is a deep learning neural network.

6. The signal data signature detection system as recited in claim 1, wherein the computer program, when executed, causes the processor to perform steps to:
receive a target audio recording distribution associated with the output type;
wherein the output label comprises at least one of a target start time or a target end time of the signal data signature recording; and
modify the signal data signature recording to produce a modified signal data signature recording based at least in part on the output label.

7. The signal data signature detection system as recited in claim 1, wherein the compendium of signal data signature classifiers are trained based on a balanced training dataset.

8. A signal data signature detection method, comprising:
receiving, by at least one processor, a signal data signature recording from at least one data source;
receiving, by the at least one processor, a dataset of labeled signal data signature recordings;
wherein the dataset of labeled signal data signature recordings comprises a dataset of signal data signature recording labels;
wherein each labeled signal data signature recording of the dataset of labeled signal data signature recordings is associated with at least one signal data signature recording label of the dataset of signal data signature recording labels:
identify, by the at least one processor, using at least one machine learning model, boundaries within the dataset of labeled signal data signature recordings;
classifying, by the at least one processor, the signal data signature recording to produce an output label using the compendium of signal data signature classifiers based on the at least one transfer learning framework;
determining, by the at least one processor, an output type of the signal data signature recording based at least in part on the output label; and
instructing, by the at least one processor, a display media to display the output type.

9. The method as recited in claim 8, wherein the at least one transfer learning framework comprises a swarm learning framework.

10. The method as recited in claim 9, wherein each signal data signature classifier in the compendium of signal data signature classifiers is a swarm node in the swarm learning framework.

11. The method as recited in claim 8, further comprising:
determining, by the at least one processor, an inductive bias in the dataset of labeled signal data signature recordings based at least in part on the dataset of signal data signature recording labels; and
utilizing, by the at least one processor, the at least one transfer learning framework comprising inductive transfer to apply the inductive bias to the compendium of signal data signature classifiers.

12. The method as recited in claim 8, wherein at least one signal data signature classifiers in the compendium of signal data signature classifiers is a deep learning neural network.

13. The method as recited in claim 8, further comprising:
receiving, by the at least one processor, a target audio recording distribution associated with the output type;
wherein the output label comprises at least one of a target start time or a target end time of the signal data signature recording; and
modifying, by the at least one processor, the signal data signature recording to produce a modified signal data signature recording based at least in part on the output label.

14. The method as recited in claim 8, wherein the compendium of signal data signature classifiers are trained based on a balanced training dataset.

15. A non-transitory computer readable medium having software instructions stored thereon, the software instructions configured to cause at least one processor to perform steps comprising:
receiving a signal data signature recording from at least one data source;
receiving a dataset of labeled signal data signature recordings;
wherein the dataset of labeled signal data signature recordings comprises a dataset of signal data signature recording labels;
wherein each labeled signal data signature recording of the dataset of labeled signal data signature recordings is associated with at least one signal data signature recording label of the dataset of signal data signature recording labels:
identifying, using at least one machine learning model, boundaries within the dataset of labeled signal data signature recordings;
classifying the signal data signature recording to produce an output label using the compendium of signal data signature classifiers based on the at least one transfer learning framework;
determining an output type of the signal data signature recording based at least in part on the output label; and
instructing a display media to display the output type.

16. The non-transitory computer readable medium as recited in claim 15, wherein the at least one transfer learning framework comprises a swarm learning framework.

17. The non-transitory computer readable medium as recited in claim 16, wherein each signal data signature classifier in the compendium of signal data signature classifiers is a swarm node in the swarm learning framework.

18. The non-transitory computer readable medium as recited in claim 15, wherein the software instructions are further configured to cause the at least one processor to perform steps comprising:
determine an inductive bias in the dataset of labeled signal data signature recordings based at least in part on the dataset of signal data signature recording labels; and
utilize the at least one transfer learning framework comprising inductive transfer to apply the inductive bias to the compendium of signal data signature classifiers.

19. The non-transitory computer readable medium as recited in claim 15, wherein at least one signal data signature classifiers in the compendium of signal data signature classifiers is a deep learning neural network.

20. The non-transitory computer readable medium as recited in claim 15, wherein the software instructions are further configured to cause the at least one processor to perform steps comprising:
receiving a target audio recording distribution associated with the output type;
wherein the output label comprises at least one of a target start time or a target end time of the signal data signature recording; and
modifying the signal data signature recording to produce a modified signal data signature recording based at least in part on the output label.
